(19) United States
(12) Patent Application Publication
(10) Pub. No.: US 2024/0398018 A1
(43) Pub. Date: Dec. 5, 2024

(54) MODULAR AEROSOL-GENERATING DEVICE WITH HEATING COMPARTMENT

(71) Applicant: Philip Morris Products S.A., Neuchatel (CH)

(72) Inventor: Rui Nuno Rodrigues Alves BATISTA, Neuchâtel (CH)

(73) Assignee: Philip Morris Products S.A., Neuchatel (CH)

(21) Appl. No.: 18/698,793

(22) PCT Filed: Oct. 11, 2022
(86) PCT No.: PCT/EP2022/078273

§ 371 Date: Apr. 5, 2024

(30) Foreign Application Priority Data
Oct. 18, 2021 (EP) 21203118.1

(51) Int. Cl. A24F 40/465; A24F 7/02; A24F 40/20; A24F 40/51; A24F 40/57; H05B 6/10

(52) U.S. Cl. CPC A24F 40/465; A24F 7/02; A24F 40/20; A24F 40/51; A24F 40/57; H05B 6/105

(57) ABSTRACT

An aerosol-generating device is provided, including: a mouthpiece including first and second planar susceptors that are arranged distanced and parallel to each other; a heating compartment including an inductor and being removably connectable to the mouthpiece; and a main body including a power supply and being removably connectable to the heating compartment, each of the first and the second planar susceptors including an inner surface pointing towards the respective other susceptor and an opposing outer surface, the inductor including a first induction coil and a second induction coil, and in which, during use, the first induction coil is situated adjacent the outer surface of the first susceptor, and the second induction coil is situated adjacent the outer surface of the second susceptor.

The present disclosure relates to an aerosol-generating device. The present disclosure further relates to an aerosol-generating system comprising an aerosol-generating device and a consumable comprising aerosol-forming substrate.

It is known to provide an aerosol-generating device for generating an inhalable vapor. Such devices may heat an aerosol-forming substrate contained in a cartridge or in an aerosol-generating article without burning the aerosol-forming substrate. The heating arrangement may be an induction heating arrangement and may comprise an induction coil and a susceptor. The susceptor may be part of the device or may be part of the article or cartridge or a mouthpiece.

Upon heating to a target temperature, the aerosol-forming substrate vaporises to form an aerosol. The aerosol-forming substrate may be present in solid form or in liquid form. A solid aerosol-forming substrate may be part of an aerosol-generating article. Removing spent aerosol-forming substrate after use may lead to a user contacting the aerosol-forming substrate. This may be undesired due to hygienic considerations or may be unpleasant for a user. Further, unwanted residues of the spent aerosol-forming substrate may remain in the aerosol-generating device leading to an undesired contamination of the device.

It would be desirable to provide an aerosol-generating device with improved hygiene. It would be desirable to provide an aerosol-generating device with improved handling of spent aerosol-forming substrate for a user. It would be desirable to provide an aerosol-generating device with improved cleaning of the device. It would be desirable to provide an aerosol-generating device which prevents unwanted contamination of the device, particularly with spent aerosol-forming substrate. It would be desirable to provide an aerosol-generating device which allows for different modes of operation.

According to an embodiment of the invention there is provided an aerosol-generating device. The aerosol-generating device may comprise a mouthpiece. The mouthpiece may comprise first and second planar susceptors that are arranged distanced and parallel to each other. The aerosol-generating device may comprise a heating compartment. The heating compartment may comprise an inductor. The heating compartment may be configured removably connectable to the mouthpiece. The aerosol-generating device may comprise a main body. The main body may comprise a power supply. The main body may be removably connectable to the heating compartment.

According to an embodiment of the invention there is provided an aerosol-generating device comprising a mouthpiece. The mouthpiece comprises first and second planar susceptors that are arranged distanced and parallel to each other. The aerosol-generating device comprises a heating compartment. The heating compartment comprises an inductor. The heating compartment is configured removably connectable to the mouthpiece. The aerosol-generating device comprises a main body. The main body comprises a power supply. The main body is removably connectable to the heating compartment.

A modular aerosol-generating device with improved hygiene may be provided. A modular aerosol-generating device with improved handling of spent aerosol-forming substrate for a user may be provided. A modular aerosol-generating device with improved cleaning of the device may be provided. A modular aerosol-generating device which prevents unwanted contamination of the device, particularly with spent aerosol-forming substrate, may be provided. A modular aerosol-generating device which allows for different modes of operation may be provided.

The heating compartment may comprise a heating chamber and an inductor. The inductor may be located outside the heating chamber. The inductor may be thermally shielded from the heating chamber. For example, the heating compartment may comprise a heating chamber having a rectangular cross-section. The heating chamber may be sandwiched between a first planar induction coil located above the heating chamber and a second planar induction coil located below the heating chamber. Layers of thermally insulating material may be provided between the heating chamber and the first and second coils, respectively.

The heating compartment may be configured removably connectable to the mouthpiece via first connection elements. The first connection elements may comprise one or more of form-locking connection elements, force-locking connection elements and snap-fit connection elements.

The main body may be removably connectable to the heating compartment via second connection elements. The second connection elements may comprise one or more of form-locking connection elements, force-locking connection elements and snap-fit connection elements.

The inductor may comprise at least one induction coil. The inductor may comprise a first induction coil and a second induction coil. One or both of the first and second induction coils may be planar.

At least during use of the device, the first induction coil may be situated adjacent the first susceptor and the second induction coil may be situated adjacent the second susceptor. When the aerosol-generating device is in an assembled ready-to-use configuration, the first induction coil may be situated adjacent the first susceptor and the second induction coil may be situated adjacent the second susceptor.

Each of the first and second susceptors may comprise an inner surface pointing towards the respective other susceptor and an opposing outer surface. At least during use of the device, the first induction coil may be situated adjacent the outer surface of the first susceptor, and the second induction coil may be situated adjacent the outer surface of the second susceptor.

At least during use of the device, the first induction coil may be situated to predominantly heat the first susceptor, and the second induction coil may be situated to predominantly heat the second susceptor.

The main body may comprise a controller and DC/AC converter configured to control supply of an alternating current from the power supply to the inductor.

The first and second induction coils may be configured to be independently operable. The controller may be configured to independently operate the first and second induction coils.

The controller may be configured to operate the first and second induction coils such that the alternating magnetic fields generated by the coils are equal in strength and oppositely oriented.

The controller may be configured to control supply of electrical energy from the power supply to the inductor on basis of the output of a temperature sensor.

The heating compartment may comprise a cavity for receiving a planar consumable comprising aerosol-forming substrate. The cavity may be configured as a heating chamber for heating the aerosol-forming substrate of the consumable.

The first and second susceptors of the mouthpiece may be arranged to at least partly extend from the mouthpiece into the cavity of the heating compartment.

Alternatively, the first and second susceptors may be arranged in the heating compartment. In this alternative embodiment, the first susceptor may be arranged at a first inner sidewall of the heating compartment or forming the first inner sidewall of the heating compartment. The second susceptor may be arranged at a second inner sidewall of the heating compartment or forming the second inner sidewall of the heating compartment. The first inner sidewall of the heating compartment may be arranged opposite the second inner sidewall of the heating compartment.

The aerosol-generating device may be configured such that, when the mouthpiece is connected to the heating compartment, the first susceptor is arranged adjacent a first lateral sidewall of the cavity, and the second susceptor is arranged adjacent an opposite second lateral sidewall of the cavity.

The mouthpiece may comprise an extension-and-retraction element configured to at least partly retract the first and second susceptors into the mouthpiece into a retracted position for ejecting the consumable.

The heating compartment may comprise at least one temperature sensor configured to measure the temperature of one or both of the first and second susceptors. The controller may be configured to control supply of electrical energy from the power supply to the inductor on basis of the output of the at least one temperature sensor of the heating compartment.

The heating compartment may comprise one or more thermal-insulating chambers. The heating compartment may comprise thermal-insulating chambers located adjacent all outer side surfaces of the heating compartment. The one or more thermal-insulating chambers may be filled with air or an inert gas at a pressure of about one atmosphere, i.e. about one bar. The one or more thermal-insulating chambers may be evacuated to lower pressures, for example 100 mbar or lower. Alternatively or in addition, the one or more thermal-insulating chambers may be filled with any suitable thermally insulating material known to the skilled person. The one or more thermal-insulating chambers may assist in thermally isolating the heated susceptor from an outer surface of the heating compartment. This may reduce the required energy for maintaining the heating chamber at a desired heated temperature. Also, the outer surface of the heating compartment may not get too hot which may improve convenience for a user to handle the device.

The invention further relates to an aerosol-generating system comprising the aerosol-generating device as described herein and a consumable as described herein.

The consumable may be planar. The consumable may be a sheet-like consumable. The consumable may be a pouch-like consumable. The consumable may comprise a solid aerosol-forming substrate. The consumable may comprise an aerosol-forming substrate in the form of a gel. The consumable may be a cartridge comprising a liquid aerosol-forming substrate. The cartridge may be releasably connectable to the mouthpiece. The cartridge may form an integral part of the mouthpiece. The cartridge may be refillable. The cartridge may be a disposable article. The mouthpiece and cartridge forming an integral unit may be reusable. The mouthpiece and cartridge forming an integral unit may be a disposable article.

As used herein, an ‘inductor’ may be a passive two-terminal electrical component that stores energy in a magnetic field when electric current flows through it. An inductor may comprise or may consist of one or more induction coils, for example one or more of a flat coil and a helical coil. The terms ‘inductor coil’ and ‘induction coil’ are used synonymously herein.

As used herein, the term ‘planar’ relates to an element having a substantially greater length and width than thickness. The length and width directions are orthogonal to one another and define a first plane. The thickness extends orthogonal to the first plane. A planar element may have two opposing major surfaces extending in plane parallel to the first plane. One or both major surfaces is advantageously flat.

The first susceptor and the second susceptor, together, may form a susceptor assembly. The first planar susceptor and the second planar susceptor may extend parallel to a first plane. The aerosol-generating device may comprise a first inductor coil and a second inductor coil, the first inductor coil positioned on a first side of the first planar susceptor and extending parallel to the first plane, the second inductor coil positioned on a second side of the second planar susceptor opposite the first side and extending parallel to the first plane. The first and second susceptors may be positioned between the first inductor coil and the second inductor coil. The aerosol-generating device may comprise a control circuitry connected to the first and second inductor coils and configured to provide an alternating current to the first and second inductor coils. Advantageously, the first and second susceptors may be substantially equidistant from the first and second inductor coils, respectively.

This arrangement may provide for efficient heating of the first and second susceptors and allows for a balance of forces exerted on the first and second susceptors by the magnetic fields generated by the first and second inductor coils.

In this context a planar susceptor is a susceptor element having a substantially greater length and width than thickness. The length and width directions are orthogonal to one another and define the first plane. The thickness extends orthogonal to the first plane. A planar susceptor may have two opposing major surfaces extending in plane parallel to the first plane. One or both major surfaces is advantageously flat.

In this context, the susceptor assembly being substantially equidistant form the first and second inductor coils means that the shortest distance between the first inductor coil and the first susceptor is between 0.8 and 1.2 times the shortest distance between the second inductor coil and the second susceptor. Even more preferably, the shortest distance between the first inductor coil and the first susceptor is substantially identical to the shortest distance between the second inductor coil and the second susceptor.

Advantageously, the first and second inductor coils are planar inductor coils. In this context a planar inductor coil means a coil that lies in a plane normal to the axis of winding of the coil. Planar inductor coils may be compact. The planar inductor coils may each lie in a plane parallel to the first plane.

The aerosol-generating device may be configured so that the at least one inductor coil provides a magnetic field at the susceptor assembly that is normal to the first plane. The system may be configured so that the first and second inductor coils provide a magnetic field at the susceptor assembly that is normal to the first plane. This allows for efficient heating of the susceptor element. It has also been found by the inventors that such an arrangement promotes efficient heating of the first and second susceptor elements such that lower frequencies of alternating of current can be used. For example, an alternating current having a frequency of between 100 KHz and 1 MHz may be used. Lower frequencies may allow for simpler electronics to be used to supply the alternating current.

The first and second planar inductor coils may have any shape, but in one advantageous embodiment each of the planar inductor coils is rectangular. The planar inductor coils may advantageously have a size and shape corresponding to a heating area of the susceptor element. The first inductor coil may have the same number of turns as the second inductor coil. The first inductor coil may have the same size and shape as the second inductor coil. The first inductor coil may be substantially identical to the second inductor coil. The first inductor coil may have an identical electrical resistance to the second inductor coil. The first inductor coil may have an identical inductance to the second inductor coil.

In one embodiment, the inductor coils are electrically connected to form a single conductive path, and the first inductor coil is wound in an opposite sense to the second inductor coil. The first and second inductor coils may then be provided with an identical alternating electrical current.

In another embodiment, the first inductor coil is wound in the same sense to the second inductor coil. The control circuitry may be configured to provide current to the first inductor coil that is directly out of phase with the current provided to the second inductor coil.

The aerosol-generating device may comprise one or more flux concentrators configured to contain a magnetic field generated by the inductor coils. The one or more flux concentrators may be configured to concentrate the magnetic field on the susceptor assembly, preferably perpendicular to the first plane.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in solid form or may be in liquid form. The terms ‘aerosol’ and ‘vapor’ are used synonymously.

The aerosol-forming substrate may be part of the consumable. The aerosol-forming substrate may be a solid aerosol-forming substrate. The aerosol-forming substrate may be part of a liquid held in a liquid storage portion of the consumable. The liquid storage portion may contain a liquid aerosol-forming substrate. Alternatively or in addition, the liquid storage portion may contain a solid aerosol-forming substrate. For example, the liquid storage portion may contain a suspension of a solid aerosol-forming substrate and a liquid. Preferably, the liquid storage portion contains a liquid aerosol-forming substrate.

The aerosol-forming substrate may comprise nicotine. The nicotine-containing aerosol-forming substrate may be a nicotine salt matrix.

The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. Alternatively, the aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the device. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1, 3-butanediol. Preferably, the aerosol former is glycerine. Where present, the homogenised tobacco material may have an aerosol-former content of equal to or greater than 5 percent by weight on a dry weight basis, and preferably from 5 percent to 30 percent by weight on a dry weight basis. The aerosol-forming substrate may comprise other additives and ingredients, such as flavourants.

As used herein, the term ‘consumable’ refers to an article comprising an aerosol-forming substrate that is capable of releasing volatile compounds that can form an aerosol. For example, a consumable may be an article that generates an aerosol that is directly inhalable by the user drawing or puffing on a mouthpiece at a proximal or user-end of the aerosol generating device. A consumable may be disposable. The consumable may be insertable into the heating chamber of the aerosol-generating device.

As used herein, the term ‘liquid storage portion’ refers to a storage portion comprising an aerosol-forming substrate that is capable of releasing volatile compounds that can form an aerosol. The liquid storage portion may be configured as a container or a reservoir for storing the liquid aerosol-forming substrate.

The liquid storage portion may be configured as a replaceable tank or container. The liquid storage portion may be any suitable shape and size. For example, the liquid storage portion may be substantially cylindrical. The cross-section of the liquid storage portion may, for example, be substantially circular, elliptical, square or rectangular.

As used herein, the term ‘aerosol-generating device’ refers to a device that interacts with a consumable to generate an aerosol.

As used herein, the term ‘aerosol-generating system’ refers to the combination of an aerosol-generating device with a consumable. In the system, the aerosol-generating device and the consumable cooperate to generate a respirable aerosol.

Preferably, the aerosol-generating device is portable. The aerosol-generating device may have a size comparable to a conventional cigar or cigarette. The device may be an electrically operated smoking device. The device may be a handheld aerosol-generating device. The aerosol-generating device may have a total length between 30 millimetres and 150 millimetres. The aerosol-generating device may have an external diameter between 5 millimetres and 30 millimetres.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise at least one air inlet. The housing may comprise more than one air inlet.

The aerosol-generating device may comprise a heating element. The heating element may comprise at least one inductor coil for inductively heating one or more susceptors.

Operation of the heating element may be triggered by a puff detection system. Alternatively, the heating element may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow path of the aerosol-generating device per time by the user. The initiation of the puff may be detected by the airflow sensor when the airflow exceeds a predetermined threshold. Initiation may also be detected upon a user activating a button. The sensor may also be configured as a pressure sensor.

The aerosol-generating device may include a user interface to activate the aerosol-generating device, for example a button to initiate heating of the aerosol-generating device or a display to indicate a state of the aerosol-generating device or of the aerosol-forming substrate.

The aerosol-generating device may include additional components, such as, for example a charging unit for recharging an on-board electric power supply in an electrically operated or electric aerosol-generating device.

As used herein, the term ‘proximal’ refers to a user-end, or mouth-end of the aerosol-generating device or system or a part or portion thereof, and the term ‘distal’ refers to the end opposite to the proximal end. When referring to the heating chamber, the term ‘proximal’ refers to the region closest to the open end of the cavity and the term ‘distal’ refers to the region closest to the closed end.

As used herein, the terms ‘upstream’ and ‘downstream’ are used to describe the relative positions of components, or portions of components, of the aerosol-generating device in relation to the direction in which a user draws on the aerosol-generating device during use thereof.

The term ‘airflow path’ as used herein denotes a channel suitable to transport gaseous media. An airflow path may be used to transport ambient air. An airflow path may be used to transport an aerosol. An airflow path may be used to transport a mixture of air and aerosol.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device. In this manner, the aerosol-forming substrate is heated by the susceptor such that an aerosol is formed.

The susceptor material may be any material that can be inductively heated to a temperature sufficient to aerosolize an aerosol-forming substrate. Suitable materials for the susceptor material include graphite, molybdenum, silicon carbide, stainless steels, niobium, aluminium, nickel, nickel containing compounds, titanium, and composites of metallic materials. Preferred susceptor materials comprise a metal or carbon. Advantageously the susceptor material may comprise or consists of a ferromagnetic or ferri-magnetic material, for example, ferritic iron, a ferromagnetic alloy, such as ferromagnetic steel or stainless steel, ferromagnetic particles, and ferrite. A suitable susceptor material may be, or comprise, aluminium. The susceptor material may comprise more than 5 percent, preferably more than 20 percent, more preferably more than 50 percent, or more than 90 percent of ferromagnetic, ferri-magnetic or paramagnetic materials. Preferred susceptor materials may be heated to a temperature in excess of 250 degrees Celsius without degradation.

The susceptor material may be formed from a single material layer. The single material layer may be a steel layer.

The susceptor material may comprise a non-metallic core with a metal layer disposed on the non-metallic core. For example, the susceptor material may comprise metallic tracks formed on an outer surface of a ceramic core or substrate.

The susceptor material may be formed from a layer of austenitic steel. One or more layers of stainless steel may be arranged on the layer of austenitic steel. For example, the susceptor material may be formed from a layer of austenitic steel having a layer of stainless steel on each of its upper and lower surfaces. The susceptor element may comprise a single susceptor material. The susceptor element may comprise a first susceptor material and a second susceptor material. The first susceptor material may be disposed in intimate physical contact with the second susceptor material. The first and second susceptor materials may be in intimate contact to form a unitary susceptor. In certain embodiments, the first susceptor material is stainless steel and the second susceptor material is nickel. The susceptor element may have a two-layer construction. The susceptor element may be formed from a stainless steel layer and a nickel layer.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding.

The aerosol-generating device may a power supply for powering the heating element. The power supply may comprise a battery. The power supply may be a lithium-ion battery. Alternatively, the power supply may be a nickel-metal hydride battery, a nickel cadmium battery, or a lithium-based battery, for example a lithium-cobalt, a lithium-iron-phosphate, lithium titanate or a lithium-polymer battery. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be a direct current (DC) power supply. In one embodiment, the power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the induction coil.

The power supply may be adapted to power an inductor coil and may be configured to operate at high frequency. A Class-E power amplifier is preferable for operating at high frequency. As used herein, the term ‘high frequency oscillating current’ means an oscillating current having a frequency of between 500 kilohertz and 30 megahertz. The high frequency oscillating current may have a frequency of from 1 megahertz to 30 megahertz, preferably from 1 megahertz to 10 megahertz, and more preferably from 5 megahertz to 8 megahertz.

In another embodiment the switching frequency of the power amplifier may be in the lower kHz range, e.g. between 100 kHz and 400 KHz. In the embodiments, where a Class-D or Class-C power amplifier is used, switching frequencies in the lower kHz range are particularly advantageous.

The aerosol-generating device may comprise a controller. The controller may be electrically connected to the inductor coil. The controller may be electrically connected to the first induction coil and to the second induction coil. The controller may be configured to control the electrical current supplied to the induction coil(s), and thus the magnetic field strength generated by the induction coil(s).

The power supply and the controller may be connected to the inductor coil(s).

The controller may be configured to be able to chop the current supply on the input side of the DC/AC converter. This way the power supplied to the inductor coil(s) may be controlled by conventional methods of duty-cycle management.

Below, there is provided a non-exhaustive list of non-limiting examples. Any one or more of the features of these examples may be combined with any one or more features of another example, embodiment, or aspect described herein.

Example A: An aerosol-generating device comprising:
a mouthpiece comprising first and second planar susceptors that are arranged distanced and parallel to each other,
a heating compartment, wherein the heating compartment comprises an inductor, and wherein the heating compartment is configured removably connectable to the mouthpiece, and
a main body, the main body comprising a power supply, wherein the main body is removably connectable to the heating compartment.

Example B: The aerosol-generating device according to Example A, wherein the heating compartment is configured removably connectable to the mouthpiece via first connection elements, wherein the first connection elements comprise one or more of form-locking connection elements, force-locking connection elements and snap-fit connection elements.

Example C: The aerosol-generating device according to Example A or Example B, wherein the main body is removably connectable to the heating compartment via second connection elements, wherein the second connection elements comprise one or more of form-locking connection elements, force-locking connection elements and snap-fit connection elements.

Example D: The aerosol-generating device according to any of the preceding examples, wherein each of the first and second susceptors comprises an inner surface pointing towards the respective other susceptor and an opposing outer surface, wherein the inductor comprises a first induction coil and a second induction coil, wherein, during use, the first induction coil is situated adjacent the outer surface of the first susceptor, and the second induction coil is situated adjacent the outer surface of the second susceptor.

Example E: The aerosol-generating device according to any of the preceding examples, wherein the inductor comprises a first induction coil and a second induction coil, wherein, during use, the first induction coil is situated to predominantly heat the first susceptor, and the second induction coil is situated to predominantly heat the second susceptor.

Example F: The aerosol-generating device according to Example D or Example E, wherein the first and second induction coils are planar.

Example G: The aerosol-generating device according to any of the preceding examples, wherein the main body comprises a controller and DC/AC converter configured to control supply of an alternating current from the power supply to the inductor.

Example H: The aerosol-generating device according to Example G and any of Examples D to F, wherein the first and second induction coils are configured to be independently operable, and wherein the controller is configured to independently operate the first and second induction coils.

Example I: The aerosol-generating device according to Example G and any of Examples D to F, wherein the controller is configured to operate the first and second induction coils such that the alternating magnetic fields generated by the coils are equal in strength and oppositely oriented.

Example J: The aerosol-generating device according to any of Examples G to I, wherein the controller is configured to control supply of electrical energy from the power supply to the inductor on basis of the output of a temperature sensor.

Example K: The aerosol-generating device according to any of the preceding examples, wherein the heating compartment comprises a cavity for receiving a planar consumable comprising aerosol-forming substrate.

Example L: The aerosol-generating device according to Example K, wherein the first and second susceptors of the mouthpiece are arranged to at least partly extend from the mouthpiece into the cavity of the heating compartment.

Example M: The aerosol-generating device according to Example L, wherein, when the mouthpiece is connected to the heating compartment, the first susceptor is configured to be arranged adjacent a first lateral sidewall of the cavity, and the second susceptor is configured to be arranged adjacent an opposite second lateral sidewall of the cavity.

Example N: The aerosol-generating device according to any of the preceding examples, wherein the mouthpiece comprises an extension-and-retraction element configured to at least partly retract the first and second susceptors into the mouthpiece into a retracted position for ejecting a consumable.

Example O: The aerosol-generating device according to any of the preceding examples, wherein the heating compartment comprises a temperature sensor configured to measure the temperature of one or both of the first and second susceptors.

Example P: The aerosol-generating device according to any of the preceding examples, wherein the heating compartment comprises one or more thermal-insulating chambers, preferably wherein the heating compartment comprises thermal-insulating chambers located adjacent all outer side surfaces of the heating compartment.

Example Q: An aerosol-generating system comprising an aerosol-generating device of any of the preceding examples and a planar consumable comprising aerosol-forming substrate.

Features described in relation to one embodiment may equally be applied to other embodiments of the invention.

The invention will be further described, by way of example only, with reference to the accompanying drawings in which:

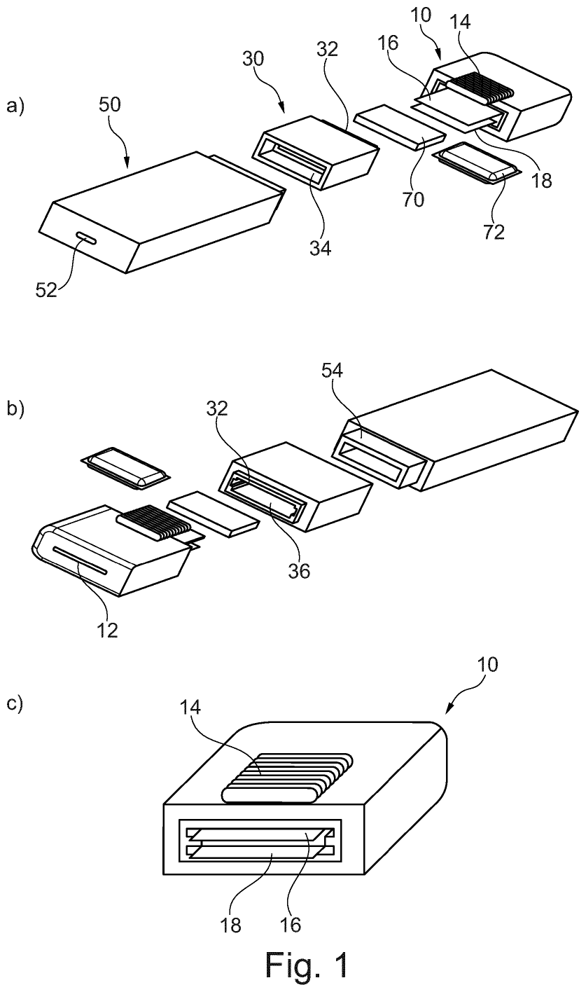

FIGS. 1a to 1c show an aerosol-generating device;

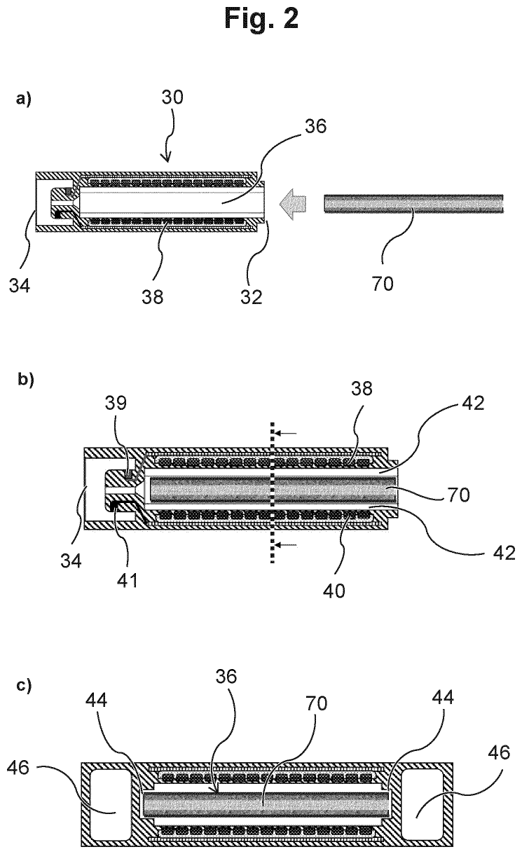

FIGS. 2a to 2c show a heating compartment;

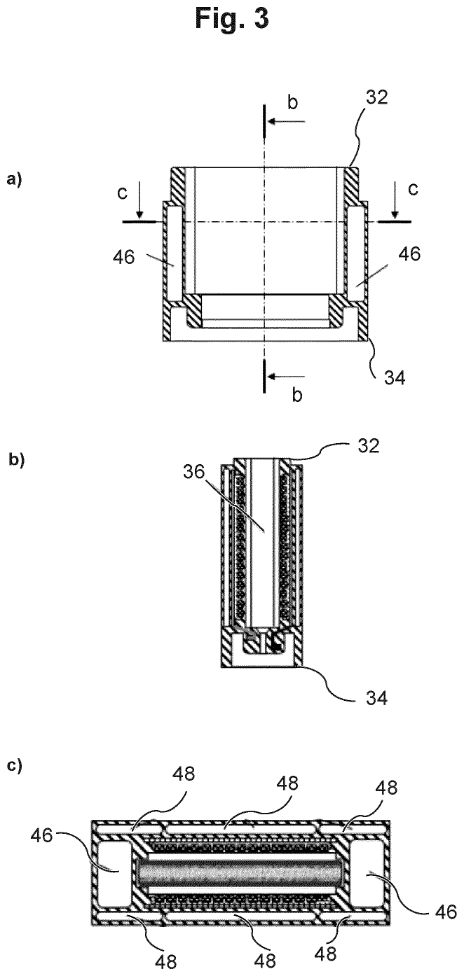

FIGS. 3a to 3c show a heating compartment; and

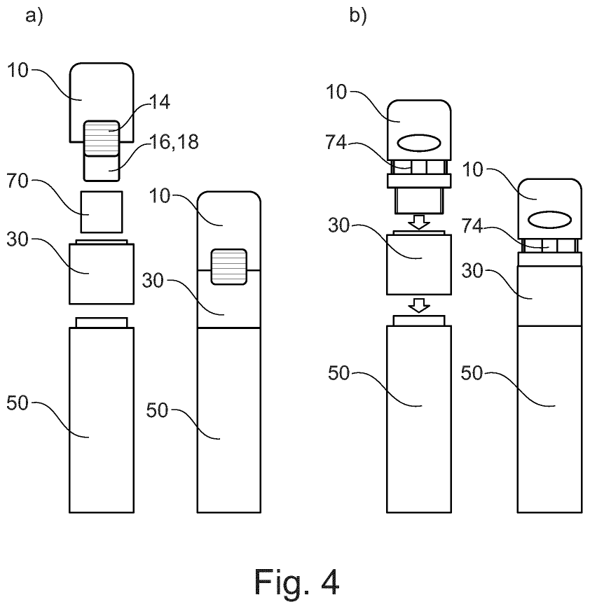

FIGS. 4a and 4b show operational modes of an aerosol-generating device.

FIGS. 1a and 1b show an aerosol-generating device in perspective view. FIG. 1b shows the aerosol-generating device in the configuration of FIG. 1a rotated by 180 degrees.

FIG. 1a shows a mouthpiece 10, a heating compartment 30, and a main body 50 of the aerosol-generating device in a detached configuration. The mouthpiece 10 is releasably attachable to a first connection element 32 of the heating compartment 30. In the attached configuration, a firm attachment may be achieved by a form fit between a protruding structure of the first connection element 32 and a corresponding recess of the mouthpiece 10. The protruding structure of the first connection element 32 can be seen best in FIG. 1b.

The main body 50 comprises control electronics and a power supply (not shown). The main body 50 comprises an air inlet 52. The main body 50 is releasably attachable to a second connection element 34 of the heating compartment 30. In the attached configuration, a firm attachment may be achieved by a form fit between a recess of the second connection element 34 and a corresponding protruding structure 54 of the main body 50. The recess of the second connection element 34 can be seen best in FIG. 1a. The protruding structure 54 can be seen best in FIG. 1b.

The heating compartment 30 comprises a cavity which is configured as a heating chamber 36 for receiving a planar consumable. The consumable may be a sheet-like consumable 70 or a pouch-like consumable 72. The heating compartment 30 further comprises an inductor (not shown).

The mouthpiece 10 comprises an air outlet 12 for an aerosol to exit the device. The mouthpiece 10 comprises a sliding element 14 arranged on an outer surface of the mouthpiece 10 and configured to be operated by a user. The mouthpiece 10 comprises first and second planar susceptors 16, 18.

The sliding element 14 and the first and second susceptors 16, 18 are part of an extension-and-retraction element which is repeatedly movable between an extended position and a retracted position and vice versa. FIGS. 1a and 1b show the mouthpiece 10 with the extension-and-retraction element being moved into the extended position. In the extended position, the first and second susceptors 16, 18 may sandwich the planar consumable.

FIG. 1c shows the mouthpiece 10 of the device of FIGS. 1a and 1b with the extension-and-retraction element being moved into the retracted position. In the retracted position, the first-and second susceptors 16, 18 are retracted at least partly into a hollow interior of the mouthpiece 10. The first-and second susceptors 16, 18 may thus sandwich and hold the consumable when being in the extended configuration and may eject the consumable when being moved into the retracted position. The extension-and-retraction element of the mouthpiece 10 is thus configured to at least partly retract the first and second susceptors 16, 18 into the mouthpiece 10 into a retracted position for ejecting a consumable.

FIGS. 2a to 2c show interaction of a heating compartment 30 and a sheet-like consumable 70 in cross-sectional views.

FIG. 2a shows the sheet-like consumable 70 to be inserted into the heating chamber 36 of the heating compartment 30 as indicated by an arrow. First and second connection elements 32, 34 are also indicated.

FIG. 2b shows the heating compartment 30 with inserted sheet-like consumable 70. The inductor of the heating compartment 30 comprises a first planar induction coil 38 and a second induction coil 40 arranged at opposite sides of the consumable 70. The consumable 70 is positioned in a centered position within the heating chamber 36 with empty channels 42 being present above and below the consumable 70. The empty channels 42 between the induction coils 38, 40 and the consumable 70 allow for the insertion of the first and second susceptors 16, 18, respectively, of the mouthpiece 10 of the embodiment of FIG. 1, when the extension-and-retraction element is moved into the extended position.

The first and second induction coils 38, 40 may comprise individual electric connectors 39, 41 which may allow individual control of the first and second induction coils 38, 40 by the control electronics of the main unit 50 when the heating compartment 30 is connected to the main unit 50 by via the second connection element 34.

FIG. 2c shows the configuration of FIG. 2b along another cross-section within a plane that is rotated by 90 degrees in comparison to FIG. 2b as indicated by arrows and a dotted line in FIG. 2b. Slits 44 at opposite sides of the heating chamber 36 are shown which allow for the consumable 70 to be held in the centered position. The heating compartment 30 further comprises lateral thermal-insulating chambers 46. The lateral thermal-insulating chambers 46 may be filled with air or an inert gas at a pressure of about one atmosphere, or they may be evacuated to lower pressures. Alternatively or in addition, the lateral thermal-insulating chambers 46 may be filled with any suitable thermally insulating material known to the skilled person.

FIGS. 3a to 3c show a modified heating compartment 30 in cross-sectional views. The planes of the cross-sections of FIGS. 3b and 3c are indicated bay arrows and a dotted lines and respective denotations “b” and “c” in FIG. 3a.

The embodiment of FIG. 3 differs from the embodiment of FIG. 2 in that the embodiment of FIG. 3 comprises additional thermal-insulating chambers 48 to allow for an additional thermal insulation of the heating chamber 36 with respect to an outer surface of the heating compartment 30. In the embodiment of FIG. 3, the heating compartment 30 comprises thermal-insulating chambers 46, 48 located adjacent all outer side surfaces of the heating compartment 30.

FIGS. 4a and 4b show two different operational modes of an aerosol-generating device in side views.

FIG. 4a shows a first operational mode of the aerosol-generating device in detached configuration on the left-hand side of FIG. 4a, and in an assembled state at the right-hand side of FIG. 4a. The first operational mode is similar to the embodiment of FIG. 1. The mouthpiece 10 comprises a sliding element 14 and first and second susceptors 16, 18. A planar substrate 70 is inserted into the heating chamber (not shown) of the heating compartment 30. The heating compartment 30 is then attached to the mouthpiece 10 and the main body 50 at opposite sides thereof to be in a ready-to-use configuration.

FIG. 4b shows a second operational mode of the aerosol-generating device in detached configuration on the left-hand side of FIG. 4b, and in an assembled state at the right-hand side of FIG. 4b. In comparison to the first operational mode, an alternative mouthpiece 11 is used in the second operational mode. The alternative mouthpiece comprises a susceptor arrangement (not shown) and a cartridge 74 comprising a liquid aerosol-forming substrate. During use, the inductor of the heating compartment 30 creates an alternating magnetic field to heat the susceptor assembly which, in turn, will heat the liquid aerosol-forming substrate within the cartridge 74 so as to evaporate inhalable components of the liquid aerosol-forming substrate.

The cartridge 74 may be releasably connectable to the remaining parts of the mouthpiece 11, or the mouthpiece 11 and the cartridge 74 may form one integral unit. In embodiments where the cartridge 74 is releasably attached to the mouthpiece 11, the susceptor assembly may form part of the replaceable cartridge portion 74, or may form part of the remaining mouthpiece portion 11.

1.-15. (canceled)

16. An aerosol-generating device, comprising:
a mouthpiece comprising first and second planar susceptors that are arranged distanced and parallel to each other;
a heating compartment comprising an inductor and being removably connectable to the mouthpiece; and
a main body comprising a power supply and being removably connectable to the heating compartment,
wherein each of the first and the second planar susceptors comprises an inner surface pointing towards the respective other susceptor and an opposing outer surface,
wherein the inductor comprises a first induction coil and a second induction coil, and
wherein, during use, the first induction coil is situated adjacent the outer surface of the first susceptor, and the second induction coil is situated adjacent the outer surface of the second susceptor.

17. The aerosol-generating device according to claim 16,
wherein the heating compartment is removably connectable to the mouthpiece via first connection elements, and
wherein the first connection elements comprise one or more of form-locking connection elements, force-locking connection elements, and snap-fit connection elements.

18. The aerosol-generating device according to claim 16,
wherein the main body is removably connectable to the heating compartment via second connection elements, and
wherein the second connection elements comprise one or more of form-locking connection elements, force-locking connection elements, and snap-fit connection elements.

19. The aerosol-generating device according to claim 16, wherein the first and the second induction coils are planar.

20. The aerosol-generating device according to claim 16, wherein the main body further comprises a controller and a DC/AC converter configured to control supply of an alternating current from the power supply to the inductor.

21. The aerosol-generating device according to claim 20,
wherein the first and the second induction coils are configured to be independently operable, and
wherein the controller is configured to independently operate the first and the second induction coils.

22. The aerosol-generating device according to claim 20, wherein the controller is configured to control supply of electrical energy from the power supply to the inductor on basis of an output of a temperature sensor.

23. The aerosol-generating device according to claim 16, wherein the heating compartment further comprises a cavity configured to receive a planar consumable comprising an aerosol-forming substrate.

24. The aerosol-generating device according to claim 23, wherein the first and the second planar susceptors are arranged to at least partly extend from the mouthpiece into the cavity of the heating compartment.

25. The aerosol-generating device according to claim 24, wherein, when the mouthpiece is connected to the heating compartment, the first planar susceptor is configured to be arranged adjacent a first lateral sidewall of the cavity, and the second planar susceptor is configured to be arranged adjacent an opposite second lateral sidewall of the cavity.

26. The aerosol-generating device according to claim 16, wherein the mouthpiece further comprises an extension-and-retraction element configured to at least partly retract the first and the second planar susceptors into the mouthpiece into a retracted position for ejecting a consumable.

27. The aerosol-generating device according to claim 16, wherein the heating compartment further comprises a temperature sensor configured to measure a temperature of one or both of the first and the second planar susceptors.

28. The aerosol-generating device according to claim 16, wherein the heating compartment further comprises one or more thermal-insulating chambers.

29. The aerosol-generating device according to claim 28, wherein the heating compartment further comprises thermal-insulating chambers located adjacent all outer side surfaces of the heating compartment.

30. An aerosol-generating system comprising an aerosol-generating device according to claim 16 and a planar consumable comprising an aerosol-forming substrate.
